(19) United States
(12) Patent Application Publication
(10) Pub. No.: US 2011/0050402 A1
(43) Pub. Date: Mar. 3, 2011

(54) ARRANGEMENT AND METHOD FOR WIRELESSLY NETWORKING DEVICES OF AUTOMATION TECHNOLOGY

(76) Inventors: Alois INEICHEN, Ruswil (CH); Thorsten GODAU, Suessen (DE)

(21) Appl. No.: 12/786,898

(22) Filed: May 25, 2010

Related U.S. Application Data
(63) Continuation of application No. PCT/EP2008/009689, filed on Nov. 15, 2008.

(30) Foreign Application Priority Data
Nov. 26, 2007 (DE) 10 2007 058 258.9

(51) Int. Cl. G08C 19/16

(52) U.S. Cl. 340/12.5

(57) ABSTRACT

An arrangement for wirelessly interconnecting devices of automation technology comprises a signal path for transmitting a high-frequency transmit signal which has a plurality of temporally successive signal packets. The arrangement has a first and a second antenna and an antenna switch which connects the signal path selectively to the first or to the second antenna. A control circuit is adapted to generate a low-frequency switching signal for the antenna switch from the successive signal packets.

### CROSS REFERENCES TO RELATED APPLICATIONS

This application is a continuation of international patent application PCT/EP2008/009689 filed on Nov. 15, 2008 designating the U.S., which international patent application has been published in German language and claims priority from German patent application DE 10 2007 058 258.9 filed on Nov. 26, 2007. The entire contents of these prior applications are incorporated herein by reference.

### BACKGROUND OF THE INVENTION

The present teachings relate to an arrangement and to a method for wirelessly networking devices of automation technology, and in particular for networking remote sensors, actuators and a central control unit.

For many years, efforts have been made in the industrial production of products to automate the process sequences more and more. This leads to an increasing networking of devices and components which are involved in the production processes. These are typically sensors for detecting installation or process states, actuators which cause a change in the installation or process states and control units for generating control signals by means of which the actuators are driven in dependence on the sensor signals. In the case of small installations, the sensors and actuators can be connected directly to the control unit. In the case of relatively large and extensive installations which need a large number of sensors and actuators, communication networks for networking the sensors, actuators and control units with one another have already been used for many years. A typical example of such communication networks are the so-called field buses. These are communication networks which are adapted to the specific requirements for such applications, especially with regard to the rough environmental conditions and the typical need for communication between control units and remote sensors and actuators. Known field buses are the so-called Profibus, the so-called Interbus and the so-called CAN bus. These field buses typically use electrical and/or optical lines for networking the linked devices.

In addition, efforts have been made for some years to implement the networking of devices of automation technology on the basis of the familiar Ethernet standard which has been successful in the networking of personal computers in home and office applications. In this connection, there are also efforts to implement the connection between the devices wirelessly, which is frequently the case already with the aid of WLAN in home and office networks. However, the technology of home and office networks cannot be easily be transferred to applications in industrial production environments because the need for communication and the environmental conditions differ. In factory workshops, there are typically a large number of metallic objects and moving objects which can greatly influence the propagation of radio waves. On the other hand, the communication between the control units and the sensors and actuators frequently has to take place in very narrow, cyclically repetitive time intervals in order to provide for a continuous and disruption-free production process. In addition to this, it is increasingly important for the communication link to be reliable if safety-related data on which the operational reliability of an automated installation is dependent are to be transmitted. For example, many production installations carry out dangerous movements which must be stopped immediately when an operator approaches the installation. In such a case, the signal from a light barrier which detects the person must be rapidly transmitted to the central control unit and the switching-off order must reach the correct drive of the installation within a defined and guaranteed period of time. In this context, it is frequently a matter of fractions of seconds in contrast to home and office networks.

In view of the difficult transmitting conditions in workshops, some transceiver devices have two rod antennas which are arranged at different positions and with different (horizontal and vertical) alignment. In each case, the antenna which finds the better receiving conditions is used.

### SUMMARY OF THE INVENTION

It is an object of the present teachings to provide an arrangement and a method which enable reliable and stable communication of networked devices under the difficult environmental conditions of a factory workshop or any other industrial environment.

It is another object of the teachings to provide an arrangement and a method which enable communication of networked devices under the difficult environmental conditions of a factory workshop or any other industrial environment in a cost-effective manner.

According to one aspect of the teachings, there is provided an arrangement for wirelessly networking remote sensors, actuators and a central control unit of an automated installation, the arrangement comprising a signal path for transmitting a high-frequency signal having a plurality of temporally successive signal packets, a first and a second antenna, an antenna switch which selectively connects the signal path to the first or to the second antenna, and a control circuit having a plurality of electronic components requiring an operating voltage, said control circuit being adapted to generate a low-frequency switching signal for the antenna switch from the successive signal packets, wherein the control circuit comprises a DC voltage circuit configured to generate a controlled DC voltage from the high-frequency signal and to provide said DC voltage as the operating voltage for the components of the control circuit.

According to a another aspect, there is provided a method for wirelessly interconnecting devices of an automation installation, the method comprising the steps of providing a first and a second antenna, providing an antenna switch which is connected to the first and to the second antenna, and providing components for actuating on the antenna switch, generating a high-frequency transmit signal which has a plurality of temporally successive signal packets, generating a low-frequency switching signal from the successive signal packets, and switching between the first and the second antenna by driving the antenna switch periodically with the low-frequency switching signal, wherein a controlled DC voltage is generated from the high-frequency transmit signal, and wherein said controlled DC voltage is used as an operating voltage for the components.

According to yet another aspect, there is provided an arrangement for wirelessly networking devices of automation technology, comprising a signal path for transmitting a high-frequency signal which has a plurality of temporally successive signal packets, comprising a first and a second antenna, comprising an antenna switch which connects the signal path selectively to the first or to the second antenna, and comprising a control circuit which is adapted to generate a low-frequency switching signal for the antenna switch from the successive signal packets.

The novel arrangements and method use at least two antennas for transmitting the signals wirelessly. However, the at least two antennas do not co-operate with one another in the sense of a transmitting antenna and a receiving antenna. Instead, the two antennas are used alternatively to one another or at least to supplement one another in order to either send out a transmit signal or to receive a receive signal. Preferably, only one of the at least two antennas is in each case in operation, with switching between the two antennas being effected with the aid of the antenna switch. In principle, it is conceivable that each networked device has at least two such antennas. However, it is provided in currently preferred exemplary embodiments that only the control units have two such antennas and transmit and receive via each of these antennas. At present, only one antenna which acts as transmitting and receiving antenna is provided for the remote sensors and actuators.

In the novel device and the novel method, the first and the second antenna operate redundantly to one another. Preferably, only one of the at least two antennas is in operation at any time. Since the at least two antennas cannot be arranged at one and the same location, they send and receive their signals at different positions. The consequence of these different positions is that the transmitting and receiving conditions can be different for each antenna. Due to the numerous reflections of a radio signal in a typical factory workshop having many, in some cases moving, metallic objects, even slight spatial differences can have the result that one antenna has good transmitting and receiving conditions whilst the other antenna has poor transmitting and receiving conditions. Since the novel device and the novel method use at least two antennas which are arranged spatially offset with respect to one another, the probability is increased that at least one of the antennas has good transmitting and receiving conditions. Switching between the antennas thus increases the availability and reliability of the radio link.

However, the novel device and the novel method are not restricted to the redundant use of a number of transmitting and receiving antennas on a networked device. In addition, a low-frequency switching signal for switching between the antennas is generated from the high-frequency signal which is transmitted and/or received via the redundant antennas. In this context, the term “low-frequency” is intended to be understood not in the sense of an absolute frequency value but relates to the switching signal having a lower signal frequency than the high-frequency radio signal which is transmitted and received via the at least two antennas.

In the novel device and the novel method, the low-frequency switching signal is generated from the signal packets which the high-frequency transmitting and receiving signal comprises. Due to the cyclic communication requirement between control units and sensors/actuators of an automated installation, the signal packets occur regularly within defined time intervals. The novel comprising and the novel method make use of the regular signal packets for generating from them a switching signal by means of which switching is effected between the antennas. In preferred embodiments, the switching occurs only in dependence on the successive signal packets, i.e. the actual transmitting and receiving conditions at the location of each antenna are ignored.

The novel comprising and the novel method can be implemented very cost-effectively. In particular, it is possible to dispense with individual measurement of the transmitting and receiving conditions at the location of each antenna since regular switching is effected in dependence on the signal packets. Due to the regular and preferably periodic switching, the transmitting and receiving conditions are regularly changed. As a result, the novel arrangement and the novel method provide for increased availability and reliability, in a very cost-effective manner, in the wireless networking of devices which are arranged in environments having difficult and varying transmitting conditions.

In a preferred refinement of the invention, a signal coupler comprising at least three terminals for dividing the high-frequency signal into part-signals is used, a first terminal being connected to the signal path and a second terminal being connected to the control circuit.

In this refinement, the high-frequency signal is divided into at least two part-signals, a first part-signal being transferred via the signal path and the antenna switch to the antennas, whilst a second part-signal is transferred to the control circuit. The at least two part-signals are equal in signal in preferred embodiments, i.e. the signal coupler only couples out of the high-frequency signal a part-signal for the control circuit. The embodiment provides for very cost-effective implementation since the control circuit can generate the low-frequency switching signal directly from the high-frequency antenna signal.

In a further refinement, the signal coupler is adapted to generate a first part-signal having a higher first signal power and a second part-signal having a lower second signal power, the second part-signal being supplied to the control circuit.

In this refinement, the signal coupler divides the high-frequency antenna signal into two part-signals which, although they may be identical with regard to their signal shape, differ with respect to their signal power. This refinement is advantageous for withdrawing as little energy as possible from the radio signal used for the communication. The second part-signal is preferably much weaker than the first part-signal. In a preferred exemplary embodiment, the coupling loss between the high-frequency signal and the second part-signal is between about 10 dB and 20 dB.

In a further refinement, the control circuit has a pulse generator which is adapted to generate a plurality of pulses in dependence on the signal packets, the plurality of pulses representing the switching signal. In a preferred exemplary embodiment, one pulse per signal packet is generated in each case.

This refinement provides for very simple and cost-effective implementation of the novel method and of the novel arrangement since the switching signal is directly correlated to the sequence of signal packets. This refinement leads to frequent switching between the antennas which is of advantage in the case of poor transmitting and receiving conditions at one of the antennas because the “poor” antenna is in each case only used briefly due to the frequent switching.

In a further refinement, the plurality of temporally successive signal packets comprises pairs of successive signal packets, the antenna switch being switched after each pair.

This refinement is of advantage because in this case, switching is effected to another antenna after each pair of signal packets. There is thus an increased probability that at least each second pair of signal packets will find better transmitting and receiving conditions. In consequence, it can be assumed that at least each second pair of signal packets can be transmitted successfully. This refinement profits from the fact that, as a rule, a failure of a signal packet in communication in an automated installation leads to the signal packet being transmitted again.

In a further refinement, the pairs of signal packets each comprise a transmit signal packet and a receive signal packet.

In this refinement, each pair of signal packets represents a communication event with request and response. This is of advantage because the transmitter of a message very rapidly receives a return message by means of which it can recognize whether the transmit message has arrived at the receiver. If each pair of signal packets comprises a transmit signal packet and a receive signal packet, this has the result, in combination with preceding refinements, that the successive communication events take place via different antennas. This refinement leads to a very simple and cost-effective diversity system.

In a further refinement, the device has a transmitter for generating a high-frequency transmit signal and a receiver for receiving a high-frequency receive signal, the transmitter and the receiver being coupled to the signal path via the signal coupler.

In this refinement, the high-frequency signal comprises both a transmit signal and a receive signal. Both signals are transferred via the signal coupler which taps off a part-signal for the control circuit. In this refinement, the control circuit receives a maximum number of signal packets. In consequence, it is possible to switch more rapidly between the antennas and the novel arrangement and the novel method can respond more rapidly to poor transmitting and receiving conditions.

In a further refinement, the control circuit has a DC voltage circuit which is adapted to generate a controlled DC voltage from the high-frequency signal. The controlled DC voltage is advantageously used as operating voltage for switching the antenna switch and for other electronic components of the device.

In this refinement, it is not only a low-frequency switching signal for the antenna switch which is generated from the high-frequency signal but, in addition, a controlled DC voltage is generated which is available as operating voltage for the components of the control circuit. This refinement has the advantage that the switching unit can be operated independently of an external power supply. The switching unit is preferably arranged in the area of the first and second antennas and in an especially preferred manner even integrated in the antennas. Due to the spatial vicinity, a relatively weak switching signal is sufficient, with the advantage that the high-frequency signal is predominantly available for the transmitting and/or receiving process. In addition, the combination of first and second antennas and control circuit can be used very flexibly. It is sufficient to connect one antenna cable to supply both the antennas and the control circuit.

It goes without saying that the features mentioned above and those still to be explained in the text which follows can be used not only in the combination specified in each case but also in other combinations or by themselves without departing from the context of the present invention.

### BRIEF DESCRIPTION OF THE DRAWINGS

Exemplary embodiments of the teachings are shown in the drawing and will be explained in greater detail in the subsequent description. In the drawing:

FIG. 1 shows a diagrammatic representation of an automated installation with a device according to an exemplary embodiment of the invention,

FIG. 2 shows a block diagram of a preferred exemplary embodiment of the novel device, and

FIGS. 3 and 4 show signal variations which can be measured at various points in the device from FIG. 2.

### DESCRIPTION OF PREFERRED EMBODIMENTS

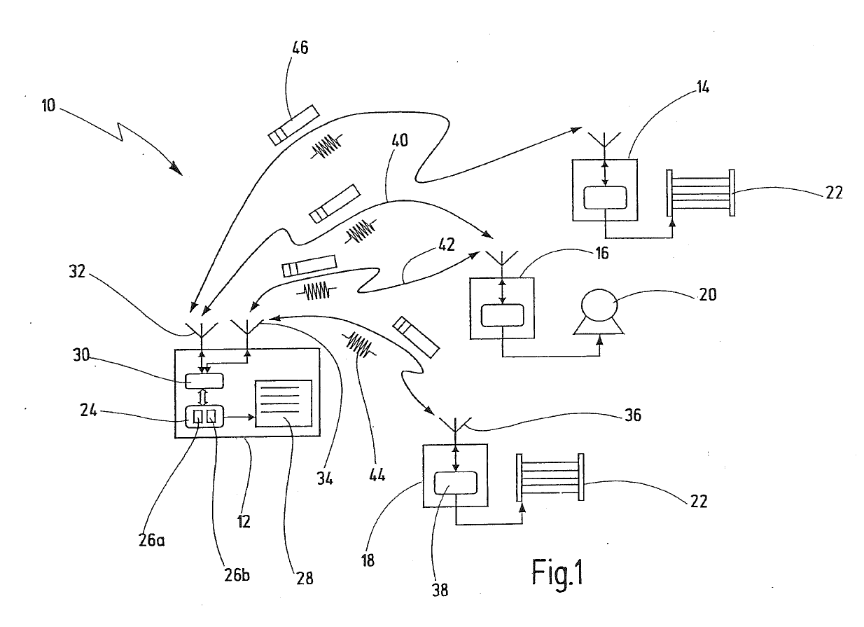

In FIG. 1, an installation in which the novel arrangement and the novel method are used is designated as a whole by reference number 10.

The installation 10 has a control unit 12 and a number of remote I/O (input/output) units 14, 16, 18. An electrical drive 20 is connected to the I/O unit 16. For example, this is an electrical drive for a robot or another machine for the automated machining of workpieces (not shown here). The drive 20 is supplied with power via the I/O unit 16 and can therefore be switched off by the I/O unit 16. A light barrier 22 is in each case connected to the I/O units 14 and 18. The light barriers 22 are used to safeguard the robot or the electrical machine against hazardous interventions. The light barriers 22 are typical examples of sensors, the signal states of which are read in by the control unit 12 in order to generate in dependence thereon control signals by means of which the drive 20 can be switched off.

The control unit 12 and the I/O units 14, 16, 18 together form a safety-related control system within the meaning of the standards EN 954-1, IEC 61508 and/or EN ISO 13849-1 in this case. In preferred exemplary embodiments, the control unit 12 and the I/O units 14, 16, 18 are in each case adapted to be failsafe in terms of Category 3 and higher of EN 954-1. To achieve this, the safety-related parts of the control unit 12 and of the I/O units 14, 16, 18 are constructed with redundancy and carry out regular functional tests in order to ensure that the drive 20 will switch off even when a fault occurs. In particularly preferred exemplary embodiments, the control unit 12 additionally comprises the operational control of drive 20, i.e. the control of the normal operating movements of the robot or of the machine. In principle, the control unit 12 could also be a pure operational control and the safety-related control functions could be controlled by another control unit (not shown here) which, for example, is installed in the switchgear cabinet of the robot or of the machine.

In the exemplary embodiment shown, the control unit 12 has a signal and data processing part 24 which is redundantly configured. The signal and data processing part 24 has two processors 26a, 26b which operate redundantly with respect to one another and monitor one another. The processors 26a, 26b can access a memory 28 in which the control program for the installation 10 is stored.

The control unit 12 also has a communication interface 30 which in the present case is connected to two antennas 32, 34. In a preferred exemplary embodiment, the two antennas 32, 34 are integrated to form one diversity antenna, the two antennas 32, 34 being arranged at a lateral distance of λ/4 from one another in preferred examples. In other exemplary embodiments, these can be two separate antennas, for instance λ/2 rod antennas which are arranged at a lateral distance of λ/4 from one another. The signal and data processing part 24 communicates with the remote I/O units 14, 16, 18 via the communication interface 30 in order to read in the signal states of the sensors 22 and to output the control commands for the drive 20.

Each I/O unit 14, 16, 18 has an antenna 36 and a communication interface 38. The I/O units 14, 16, 18 communicate with the control unit 12 via the antenna 36 and the communication interface 38 in order to transmit the sensor signals and to receive the control commands. For this purpose, the communication interfaces 30, 38 transmit and receive high-frequency radio signals 40, 42. In one exemplary embodiment, the frequency of the radio signals 40, 42 is about 2.4 GHz. Each radio signal comprises a plurality of temporally successive signal packets (so-called bursts), between which there are temporal pauses. The high-frequency signal packets transmit so-called telegrams 46 in which the data which are exchanged between the control unit 12 and the I/O units 14, 16, 18 are coded. In a preferred exemplary embodiment, the control unit 12 sequentially communicates with the individual I/O units 14, 16, 18 which are distinguished by addresses transmitted as a component of the telegrams 46. Each I/O unit 14, 16, 18 addressed responds to a transmit telegram of the control unit 12 with a corresponding response telegram. As is shown in FIG. 1, the control unit 12 alternately uses one of the antennas 32, 34 for this communication in each case, the change between the antennas 32, 34 in each case taking place in a preferred exemplary embodiment when the control unit 12 has sent out a transmit signal packet to an I/O unit 14, 16, 18 and received a corresponding receive signal packet. In principle, the change between the antennas 32, 34 (and possibly other antennas which are not shown here) is also possible in accordance with another arrangement.

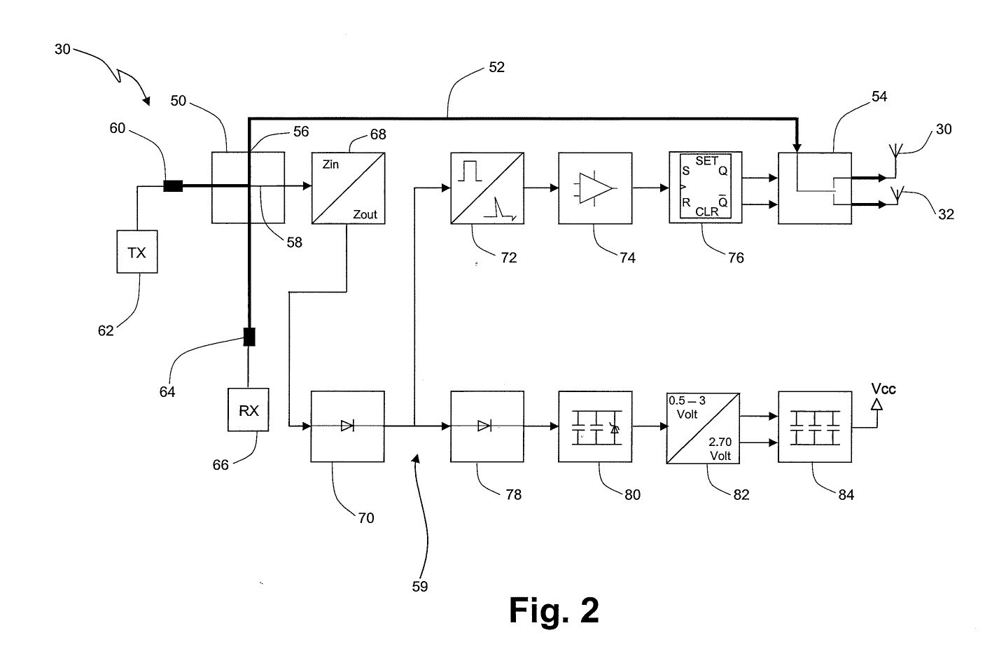

FIG. 2 shows a preferred exemplary embodiment of the communication interface 30 of the control unit 12. In principle, the communication interfaces 38 in the I/O units can also be equipped with a number of antennas. In the currently preferred exemplary embodiments, however, simple antenna and communication interfaces 38 are used in the I/O units 14, 16, 18.

As is shown in FIG. 2, the communication interface 30 has a signal coupler 50 which is connected to the two antennas 32, 34 via a signal path 52 and an antenna switch 54. The antenna switch 54 is adapted to selectively connect the signal path 52 to the antenna 32 or to the antenna 34.

The signal coupler 50 has in this case four terminals. The signal path 52 is connected to a first terminal 56. A control circuit 59, the operation of which is explained further below, is connected to a second terminal 58. A transmitter 62 is here connected to a further terminal 60. A receiver 66 is connected to a fourth terminal 64. The signal coupler 50 is adapted in such a manner that a high-frequency transmit signal of the transmitter 62 which is fed in at the terminal 60 is divided between the terminals 56, 58, the first part-signal at the terminal 56 having a much higher power than the second part-signal at the terminal 58. In one exemplary embodiment, the coupling loss between the terminals 60 and 58 is about 16 dB. In contrast, the coupling loss between the terminals 58 and 56 is greater than 20 dB and preferably even greater than 30 dB. In a preferred exemplary embodiment, the coupling loss between the terminals 58 and 56 is about 35 dB. The result of this high coupling loss is that signal components which are generated in the control circuit 59 are not radiated via the antennas 32, 34.

When a response telegram is received, the high-frequency receive signal is transmitted via the signal path 52 and distributed here to the terminals 58 and 64. In another preferred exemplary embodiment, the signal coupler 50 can use only the terminals 56, 58, 60 and the antenna signals are distributed between the transmitter 62 and the receiver 66 via a further switch, not shown here, which is connected to the terminal 60.

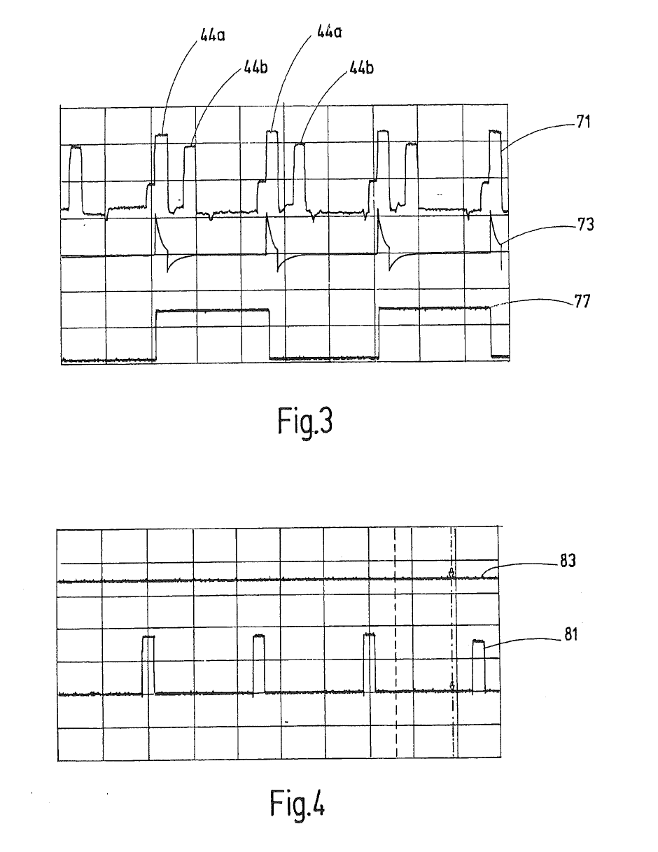

The control circuit 59 has at its input an impedance transformer 68 which has preferably been produced in microstrip technology. The impedance trans-former 68 is used for adapting the impedance of the signal path 52 to the impedance of the subsequent rectifier circuit 70. The rectifier circuit 70 in this case contains a Schottky diode and a so-called charge pump (not shown). The rectifier circuit 70 is adapted to transform the high-frequency antenna signal on the signal path 52 into a pulsating DC voltage which is shown at reference number 71 in FIG. 3. Each pulse of the pulsating DC voltage 71 represents one signal packet 44. As can be seen in FIG. 3, in each case two signal packets 44a, 44b follow one another relatively closely in this case. After each pair of signal packets 44a, 44b, a slightly longer pause follows which is followed by the next pair of signal packets 44a, 44b. The signal packets 44a are in this case transmit signal packets which are sent out via one of the antennas 32, 34. The signal packets 44b are receive signal packets which are received via one of the antennas 32, 34.

After the rectifier circuit 70, the control circuit 59 is divided into two parts. A first branch of the control circuit 59 comprises a differentiator 72, a comparator 74 and a flip-flop 76. The differentiator 72 is used as an edge (or slope) detector. It generates a signal 73 with a plurality of needle pulses, each needle pulse corresponding to a rising edge of the pulsating DC voltage 71. The comparator 74 is used as pulse shaper which forms from the needle pulses of the signal 73 rectangular pulses by means of which the flip-flop 76 is triggered. At the output of the flip-flop 76, an antenna switching signal (Q and nQ) is available which is shown with reference number 77 in FIG. 3. The flip-flop 76 alternately switches the antenna switch 54 so that the antenna 32 and the antenna 34 are alternately used for transmitting and receiving.

In the second signal branch of the control circuit 59, the pulsating voltage 71 at the output of the rectifier circuit 70 is conducted via a diode 78 to a so-called buffer limiter 80. The buffer limiter 80 is a circuit for storing and limiting with the aid of which the pulsating DC voltage is smoothed. The smoothed DC voltage at the output of the buffer limiter 80 is supplied to a DC/DC converter 82 which generates a controlled DC voltage 83. The controlled DC voltage is shown with the reference number 83 in FIG. 4. The curve 81 below that shows the pulsating DC voltage at the input of the buffer limiter 80. At the output of the DC/DC converter 82, a storage capacitor 84 is arranged which temporarily stores the controlled DC voltage 83. The stored DC voltage 83 is used as the operating voltage with which the electronic components of the control circuit 59, particularly the differentiator 72, the comparator 74 and the flip-flop 76 are supplied.

In the preferred exemplary embodiment, the antenna switch 54 is driven with the output Q and the negated output nQ of the flip-flop 76 in such a manner that the antennas 32, 34 alternately radiate the transmit signals of the control unit 12. In other words, an antenna change is effected here in such a manner that two successive transmit bursts are radiated via different antennas. The change from one antenna to the other takes place after the associated receive signal has been received by the I/O unit addressed. In principle, however, it is also possible that the control unit 12 sends out its transmit signals via one of the two antennas 30, 32 until a change to the other antenna has been initiated by the fact that a corresponding receive signal fails to appear. In all exemplary embodiments, it is preferred that the control unit 12 repeats a transmit telegram when a corresponding receive telegram fails to appear as response.

In the preferred exemplary embodiments, the control unit 12 transmits transmit signals in defined, periodic time intervals. Correspondingly, it is possible to switch from one antenna to the other in the defined time intervals. Furthermore, the transmit signal packets and receive signal packets occurring periodically supply the control circuit 59 with energy from which the operating voltage is generated with the aid of the DC/DC converter 82. The storage capacitor 84 ensures that short voltage dips can be bridged if the sending out and/or receiving of signals is delayed.

What is claimed is:

1. An arrangement for wirelessly networking remote sensors, actuators and a central control unit of an automated installation, the arrangement comprising:
a signal path for transmitting a high-frequency signal having a plurality of temporally successive signal packets;
a first and a second antenna;
an antenna switch which selectively connects the signal path to the first or to the second antenna; and
a control circuit having a plurality of electronic components requiring an operating voltage, said control circuit being adapted to generate a low-frequency switching signal for the antenna switch from the successive signal packets,
wherein the control circuit comprises a DC voltage circuit configured to generate a controlled DC voltage from the high-frequency signal and to provide said DC voltage as the operating voltage for the components of the control circuit.

2. The arrangement of claim 1, further comprising a signal coupler comprising at least three terminals for dividing the high-frequency signal into part-signals, a first terminal being connected to the signal path and a second terminal being connected to the control circuit.

3. The arrangement of claim 2, wherein the signal coupler is adapted to generate a first part-signal having a higher first signal power and a second part-signal having a lower second signal power, the second part-signal being supplied to the control circuit.

4. The arrangement of claim 1, wherein the control circuit has a pulse generator adapted to generate a plurality of pulses in dependence on the signal packets, the plurality of pulses representing the switching signal.

5. The arrangement of claim 4, further comprising a bistable flip-flop which receives the plurality of pulses in order to generate the switching signal.

6. The arrangement of claim 2, further comprising a transmitter for generating a high-frequency transmit signal and a receiver for receiving a high-frequency receive signal, the transmitter and the receiver being coupled to the signal path via the signal coupler.

7. A method for wirelessly interconnecting devices of an automation installation, the method comprising the steps of:
providing a first and a second antenna;
providing an antenna switch which is connected to the first and to the second antenna, and providing components for actuating on the antenna switch;
generating a high-frequency transmit signal which has a plurality of temporally successive signal packets;
generating a low-frequency switching signal from the successive signal packets; and
switching between the first and the second antenna by driving the antenna switch periodically with the low-frequency switching signal,
wherein a controlled DC voltage is generated from the high-frequency transmit signal, and
wherein said controlled DC voltage is used as an operating voltage for the components.

8. The method of claim 7, wherein the plurality of temporally successive signal packets comprise pairs of successive signal packets, with the antenna switch being switched after each pair.

9. The method of claim 8, wherein the pairs of signal packets each comprise a transmit signal packet and a receive signal packet.

10. An arrangement for wirelessly networking devices of automation technology, comprising a signal path for transmitting a high-frequency signal which has a plurality of temporally successive signal packets, comprising a first and a second antenna, comprising an antenna switch which connects the signal path selectively to the first or to the second antenna, and comprising a control circuit which is adapted to generate a low-frequency switching signal for the antenna switch from the successive signal packets.

11. The arrangement of claim 10, further comprising a signal coupler comprising at least three terminals for dividing the high-frequency signal into part-signals, a first terminal being connected to the signal path and a second terminal being connected to the control circuit.

12. The arrangement of claim 11, wherein the signal coupler is adapted to generate a first part-signal having a higher first signal power and a second part-signal having a lower second signal power, the second part-signal being supplied to the control circuit.

13. The arrangement of claim 10, wherein the control circuit has a pulse generator adapted to generate a plurality of pulses in dependence on the signal packets, the plurality of pulses representing the switching signal.

14. The arrangement of claim 13, further comprising a bistable flip-flop which receives the plurality of pulses in order to generate the switching signal.

15. The arrangement of claim 11, further comprising a transmitter for generating a high-frequency transmit signal and a receiver for receiving a high-frequency receive signal, the transmitter and the receiver being coupled to the signal path via the signal coupler.

16. The arrangement of claim 11, wherein the control circuit has a DC voltage circuit adapted to generate a controlled DC voltage from the high-frequency signal.
